(19) United States
(12) Patent Application Publication
(10) Pub. No.: US 2021/0285365 A1
(43) Pub. Date: Sep. 16, 2021

(54) SUPERCHARGING PRESSURE CONTROL DEVICE OF INTERNAL COMBUSTION ENGINE

(71) Applicant: Honda Motor Co., Ltd., Tokyo (JP)

(72) Inventors: Jyo ISHIMASA, Saitama (JP); Masaki UENO, Saitama (JP)

(73) Assignee: Honda Motor Co., Ltd., Tokyo (JP)

(21) Appl. No.: 17/198,251

(22) Filed: Mar. 11, 2021

(30) Foreign Application Priority Data
Mar. 13, 2020 (JP) 2020-044004

(51) Int. Cl. F02B 37/22

(52) U.S. Cl. CPC F02B 37/22

(57) ABSTRACT

A supercharging control device of an internal combustion engine includes: a supercharger, disposed in the internal combustion engine, and configured to increase a supercharging pressure by changing a variable nozzle opening degree to a closed side; a supercharging pressure obtaining part, obtaining the supercharging pressure; a limit value setting part, setting a limit value which setting the opening degree of the closed side of the variable nozzle based on a pressure of a side of a turbine of the supercharger; and an opening degree setting part, setting the opening degree of the variable nozzle to the limit value when the supercharging pressure is increased toward a target supercharging pressure, and then gradually setting to an open side.

### CROSS-REFERENCE TO RELATED APPLICATION

This application claims the priority benefit of Japan application serial no. 2020-044004, filed on Mar. 13, 2020. The entirety of the above-mentioned patent application is hereby incorporated by reference herein and made a part of this specification.

### BACKGROUND

### Technical Field

The disclosure relates to a supercharging pressure control device of an internal combustion engine, and more particularly to a supercharging pressure control device using a supercharger having a variable nozzle for changing the supercharging pressure.

### Description of Related Art

As a supercharger used in an internal combustion engine of an automobile, etc., a variable-capacity supercharger is known. In the variable-capacity supercharger, by changing the angles of a plurality of nozzle vanes of a variable nozzle disposed in a turbine housing, the area of an exhaust flow path is changed, and the flow speed of the exhaust gas toward a turbine wheel is thus changed, thereby controlling the supercharging pressure.

In such variable-capacity supercharger, in the case in which a failure occurs, such as the variable nozzle being stuck, the supercharging pressure or exhaust pressure (exhaust pressure on the upstream side of the turbine wheel) keeps increasing. As a result, the internal combustion engine or the supercharger may fail. Therefore, various techniques for preventing the supercharger from failing has been proposed.

For example, in a control device of a turbo charger disclosed in Patent Document 1, in the case where the detected variable nozzle opening degree is equal to or less than an extreme nozzle opening degree, and the detected turbo rotation speed falls within a resonance-inducing area, and the detected pressure at the inlet of the turbine is equal to or higher than an extreme turbine inlet pressure, the turbo charger is determined as in a damage-inducing state. Then, in the case where the turbo charger is determined as in the damage-inducing state, the opening degree of the variable nozzle is increased to eliminate the damage-inducing state.

### PRIOR ART DOCUMENT

### Patent Document

Patent Document 1: Japanese Laid-open No. 2009-13963

In the technique disclosed in Patent Document 1, after the supercharger is verified as entering the damage-inducing state based on the three parameters, the opening degree of the variable nozzle is increased to eliminate the damage-inducing state. Therefore, an overshoot of the supercharging pressure during acceleration cannot be avoided, and the damage-inducing state cannot be reliably prevented from occurring.

### SUMMARY

According to an embodiment of the present disclosure, a supercharging pressure control device of an internal combustion engine is provided. The supercharging pressure control device includes a supercharger, disposed in the internal combustion engine, and configured to increase a supercharging pressure by changing an opening degree of a variable nozzle to a closed side, wherein the supercharger comprises a turbine rotationally driven by kinetic energy of exhaust gas and comprises a compressor provided in an intake path and connected to the turbine via a shaft; a supercharging pressure obtaining part, obtaining the supercharging pressure; a limit value setting part, setting a limit value which limits the opening degree of the closed side of the variable nozzle based on a pressure of a turbine side of the supercharger; and an opening degree setting part, setting the opening degree of the variable nozzle to the limit value when the supercharging pressure is increased toward a target supercharging pressure, and then gradually setting the opening degree of the variable nozzle to an open side.

### BRIEF DESCRIPTION OF THE DRAWINGS

FIG. 1 is a diagram schematically showing a configuration of an internal combustion engine.

FIG. 2 is a schematic cross-sectional diagram of a variable nozzle of a variable-capacity supercharger.

FIG. 3 is a block diagram showing a configuration of a control device of an internal combustion engine.

FIG. 4 is a flowchart showing a process for setting an opening degree of a variable nozzle.

FIG. 5 is a map for setting a limit value of an opening degree of a variable nozzle based on an expansion ratio limit and a required turbine work load.

### DESCRIPTION OF THE EMBODIMENTS

The disclosure provides a supercharging pressure control device of an internal combustion engine capable of preventing the overshoot of the supercharging pressure during acceleration from occurring, effectively avoiding a failure of the supercharger, and facilitating supercharging responsiveness.

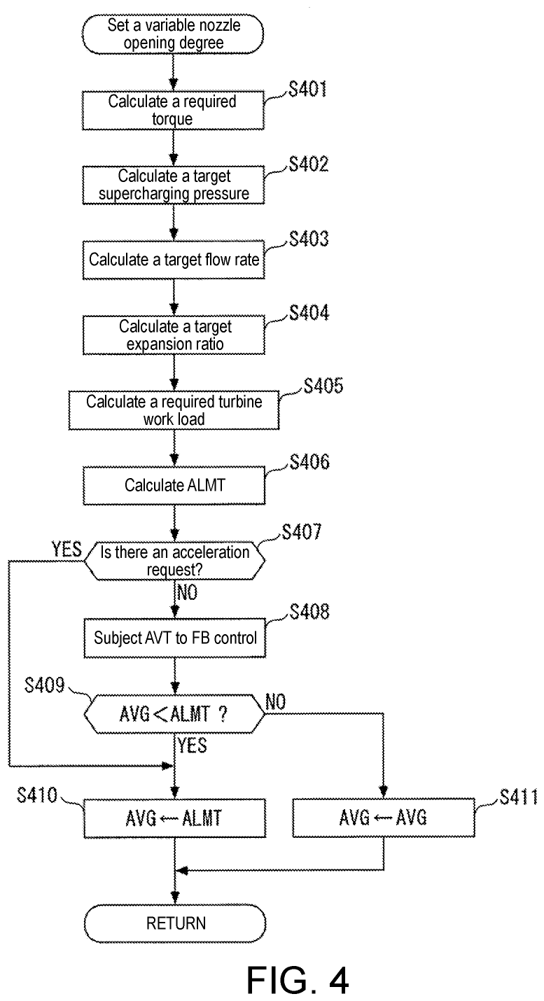

A supercharging control device of an internal combustion engine according to an aspect of the disclosure includes: a supercharger (turbo charger 12), disposed in the internal combustion engine (engine 1), and configured to increase a supercharging pressure PB by changing an opening degree AVG of a variable nozzle 124 to a closed side; a supercharging pressure obtaining part (supercharging pressure sensor 21), obtaining the supercharging pressure; a limit value setting part (ECU 20, FIG. 4), setting a limit value ALMT which setting the opening degree of the closed side of the variable nozzle based on a pressure (expansion ratio limit RLMT) of a turbine side of the supercharger; and an opening degree setting part (ECU 20, FIG. 4), setting the opening degree of the variable nozzle to the limit value when the supercharging pressure is increased toward a target supercharging pressure PBCMD, and then gradually setting the opening degree of the variable nozzle to an open side.

According to the supercharging pressure control device of the internal combustion engine of the disclosure, with the limit value setting part, the limit value which limits the opening degree of the closed side of the variable nozzle is set based on the pressure of the turbine side of the supercharger, and with the opening degree setting part, the opening degree of the variable nozzle is set to the limit value when the supercharging pressure is increased toward the target supercharging pressure, and then the opening degree is gradually set to the open side. Accordingly, by limiting the opening degree of the closed side of the variable nozzle based on the pressure of the turbine side, the failure of the supercharger is effectively avoided. In addition, through the feedforward control which sets the limit value of the opening degree of the variable nozzle, an overshoot of the supercharging pressure can be prevented from occurring. In addition, when the supercharging pressure is increased toward the target supercharging pressure, by setting the opening degree of the variable nozzle to a limit value of a full closure side, the supercharging responsiveness can be facilitated.

According to an embodiment of the disclosure, in the supercharging pressure control device, the limit value of the opening degree of the variable nozzle is a value smaller than an opening degree corresponding to the target supercharging pressure and greater than an opening degree of full closure.

According to the configuration, since the limit value of the opening degree of the variable nozzle is a value described above, the opening degree setting part sets the opening degree of the variable nozzle to a limit value smaller than the opening degree corresponding to the target supercharging pressure and a value greater than the opening degree of full closure, and then gradually sets the opening degree of the variable nozzle to the open side. Accordingly, when the supercharging pressure is increased, by setting the opening degree of the variable nozzle to be close to the open side than the opening degree of full closure, the failure of the supercharger is avoided, and by setting the opening degree of the variable nozzle to be close to the closed side than the opening degree corresponding to the target supercharging pressure, the supercharging responsiveness can be increased.

According to an embodiment of the disclosure, in the supercharging pressure control device, the pressure of the turbine side is an expansion ratio which is a ratio between a pressure of an upstream side of a turbine and a pressure of a downstream side of the turbine.

According to the configuration, since the opening degree of the closed side of the variable nozzle is limited based on the expansion ratio which is the ratio between the upstream pressure and the downstream pressure of the turbine, by reflecting the exhaust temperature or the atmospheric pressure, etc., with respect to the upstream pressure (exhaust pressure) of the turbine, the failure of the supercharger when the exhaust temperature or the atomspheric temperature changes can be effectively avoided.

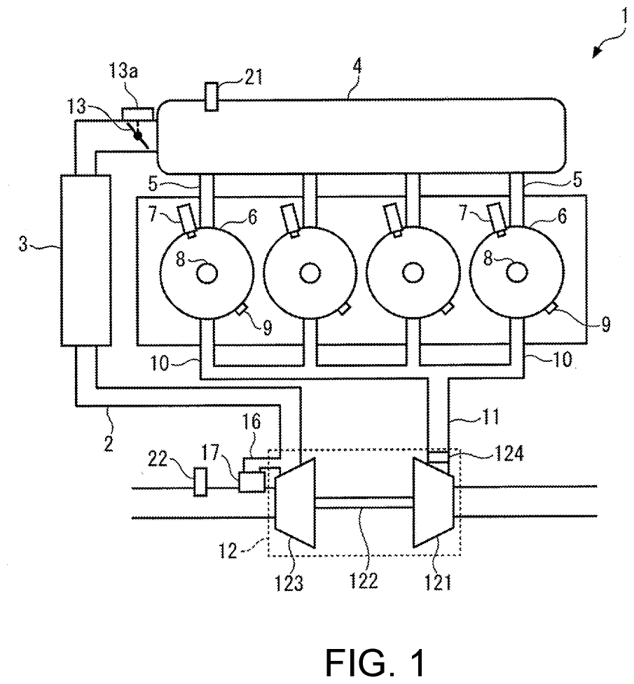

Hereinafter, exemplary embodiments of the disclosure will be described in detail with reference to the drawings. As shown in FIG. 1, an internal combustion engine (hereinafter referred to as the engine) 1 is mounted on a vehicle, has, for example, four cylinders 6 in series, and is a direct injection engine which directly injects fuel into combustion chambers (not shown) of the cylinders 6. Each cylinder 6 is provided with a fuel injection valve 7, a spark plug 8, an intake valve and an exhaust valve (neither of which is shown). Further, a crankshaft which converts the reciprocating motion of a piston in the combustion chamber into rotational motion (none of which is shown) is provided with a rotation speed sensor 9 which detects the rotation speed of the engine 1 (engine rotation speed NE).

Further, the engine 1 includes an intake path 2, an exhaust path 11, and a turbo charger 12 as a supercharger. The intake path 2 is connected to a surge tank 4, and the surge tank 4 is connected to the combustion chamber of each cylinder 6 via an intake manifold 5. The intake path 2 is provided with a compressor 123 (to be described later) of the turbo charger 12, an intercooler 3 for cooling the air pressurized by the turbo charger 12, and a throttle valve 13 from the upstream side in this order. The throttle valve 13 is driven by a throttle (TH) actuator 13a. The surge tank 4 is provided with a supercharging pressure sensor 21 which detects the supercharging pressure PB, and the intake path 2 is provided with an intake air flow rate sensor 22 which detects the intake air flow rate GAIR.

The turbo charger 12 includes a turbine 121 provided in the exhaust path 11 and rotationally driven by the kinetic energy of the exhaust gas, and includes the compressor 123 provided in the intake path 2 and connected to the turbine 121 via a shaft 122. The compressor 123 pressurizes the air (intake gas) taken into the engine 1 and supercharges it. A bypass path 16 which bypasses the compressor 123 is connected to the intake path 2, and the bypass path 16 is provided with an air bypass valve (AB valve) 17 for adjusting the flow rate of air passing through the bypass path 16.

The exhaust path 11 is connected to the combustion chamber of each cylinder 6 via an exhaust manifold 10. The exhaust path 11 is provided with the turbine 121 having a variable nozzle 124. The variable nozzle 124, as to be described afterwards, adjusts the flow rate of air (exhaust gas) passing through the variable nozzle 124 by changing the flow path area, thereby changing the supercharging efficiency.

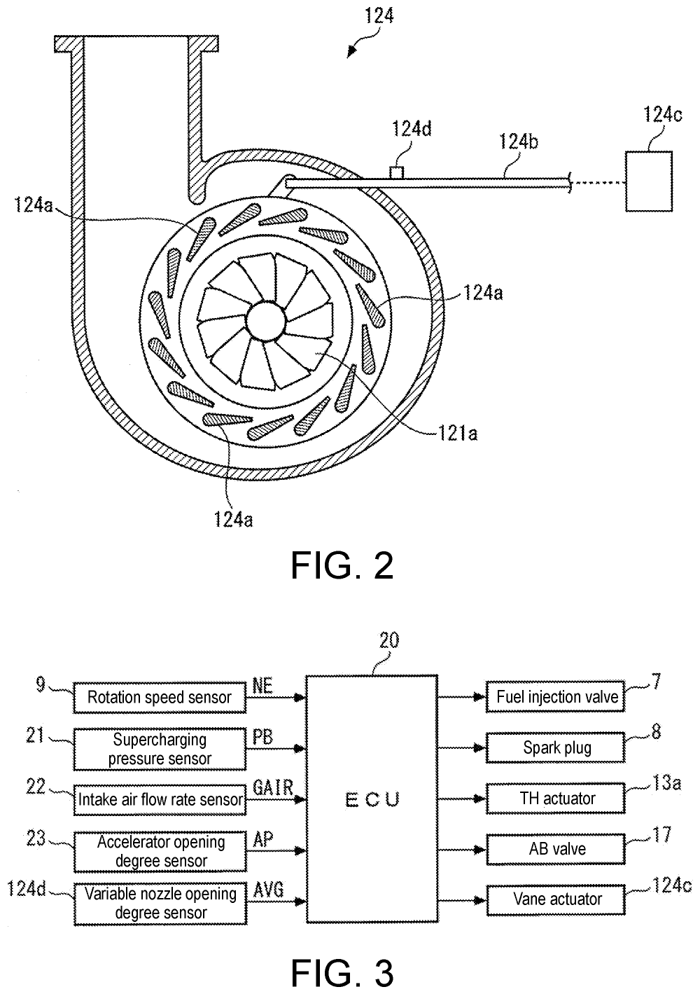

As shown in FIG. 2, the variable nozzle 124 includes multiple nozzle vanes 124a provided in a housing of the turbine 121 and having changeable angles. Each nozzle vane 124a is connected to a vane actuator 124c via a rod 124b, and when the rod 124b is driven by the vane actuator 124c, the angle of each nozzle vane 124a is changed accordingly. Further, the rod 124b is provided with a variable nozzle opening degree sensor 124d which detects the angle of the nozzle vane 124a as the opening degree of the variable nozzle (variable nozzle opening degree AVG).

In the disclosure, the variable nozzle opening degree AVG means the angles of the nozzle vanes 124a, and when it is described that the variable nozzle opening degree AVG is decreased or controlled to the closed side, it means that all the nozzle vanes 124a are driven in a direction in which the distance between two adjacent nozzle vanes 124a is narrowed. Further, when it is described that the variable nozzle opening degree AVG is increased or controlled to the open side, it means that all the nozzle vanes 124a are driven in a direction in which the distance between two adjacent nozzle vanes 124a is widened. Further, for example, AVG=0% means the minimum opening degree that may be controlled during the operation of the engine 1, and AVG=100% means the maximum opening degree that may be controlled during the operation of the engine 1.

Based on the above definition, when the variable nozzle opening degree AVG is decreased, the distance between the nozzle vanes 124a is narrowed, whereby the flow path area of the exhaust gas toward a turbine wheel 121a is decreased. In this way, the flow rate of the exhaust gas passing through the variable nozzle 124 increases, and the rotation speed of the turbine wheel 121a increases, whereby the rotation speed of the compressor 123 integrally connected to the turbine 121 increases, and the supercharging pressure PB increases. On the contrary, when the variable nozzle opening degree AVG is increased, the distance between the nozzle vanes 124a is widened, whereby the flow path area is widened, and the flow rate of the passing exhaust gas decreases, so the rotation speeds of the turbine wheel 121a and the compressor 123 decrease, and the supercharging pressure PB decreases.

FIG. 3 shows a configuration of a control device of the engine 1. An electronic control unit (hereinafter referred to as the ECU) 20 is configured by a microcomputer including a CPU, a RAM, a ROM, an I/O interface (none of which is shown), and the like. In addition to the supercharging pressure sensor 21, the intake air flow rate sensor 22, the variable nozzle opening degree sensor 124d and the rotation speed sensor 9 described above, an accelerator opening degree sensor 23 which detects the operation amount (accelerator opening degree AP) of the accelerator pedal of the vehicle and the like are also connected to the ECU 20, and detection signals thereof are sequentially input to the ECU 20. The fuel injection valve 7, the spark plug 8, the TH actuator 13a, the vane actuator 124c, the AB valve 17 and the like are connected to the output side of the ECU 20.

The ECU 20 controls the engine 1 according to the detection signals of the various sensors described above and the like. Specifically, in the embodiment, the ECU 20 controls the supercharging pressure PB by changing the opening degree AVG of the variable nozzle 124 according to the operating state of the engine 1 (mainly the engine rotation speed NE and the accelerator opening degree AP).

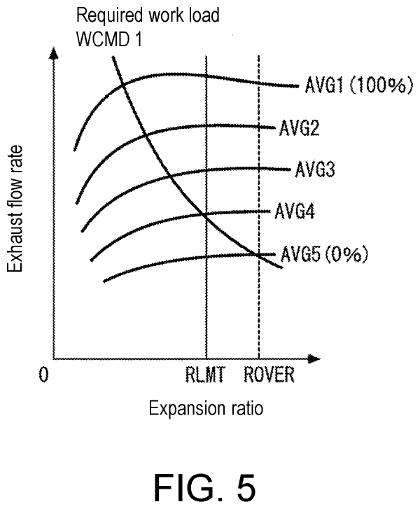

Hereinafter, the supercharging pressure control in the embodiment will be described with reference to FIGS. 4 and 5. In the supercharging pressure control, a limit value ALMT, which limits the opening degree of the closed side of the variable nozzle opening degree AVG, is set based on the pressure on the turbine 121 side. Then, at the time when there is an acceleration request from the vehicle, the variable nozzle opening degree AVG is set to the limit value ALMT, and at the time when there is no acceleration request, in the case where the variable nozzle opening degree AVG falls below the limit value ALMT, the variable nozzle opening degree AVG is set to the limit value ALMT.

In the embodiment, regarding the setting of the limit value ALMT, an expansion ratio, which is a ratio between the pressure (exhaust pressure) of the upstream side of the turbine 121 and the pressure of the downstream side thereof is used as the pressure on the turbine 121 side. Specifically, at the time when the expansion ratio exceeds a predetermined extreme value (extreme expansion ratio ROVER), a state in which the exhaust pressure has excessively increased and there is a high possibility that a failure of the turbine, etc., may occur is determined, and a lower predetermined expansion ratio is set in advance as an expansion ratio limit RLMT so as not to exceed the extreme expansion ratio ROVER. Then, based on a required work load WCMD of the turbine 121 determined by the request of the vehicle (the engine rotation speed NE and the accelerator opening degree AP) and the expansion ratio limit, the limit value ALMT of the variable nozzle opening degree AVG is set.

FIG. 4 is a flowchart showing a process for setting the variable nozzle opening degree AVG This process is repeatedly executed in the ECU 20 at predetermined time intervals. In the process, firstly, in Step 401 (shown as “S401”, the same applies to the following), a required torque is calculated based on the engine rotation speed NE and the accelerator opening degree AP. Then, in Step 402, a target supercharging pressure PBCMD is calculated based on the engine rotation speed NE and the required torque. Then, in Step 403, a target flow rate is calculated based on the engine rotation speed NE and the required torque. Then, in Step 404, a target expansion ratio is calculated based on the target supercharging pressure PBCMD.

Then, in Step 405, based on the target flow rate and the target expansion ratio, etc., calculated in Step 403 and Step 404, the required turbine work load WCMD is calculated by using a conventional formula for deriving the turbine work load. The required turbine work load WCMD is a work load of the turbine required for increasing the supercharging pressure PH to the target supercharging ratio PBCMD.

Next, in Step 406, the limit value ALMT of the variable nozzle opening degree AVG is set by searching a map shown in FIG. 5 based on the required turbine work load WCMD and the expansion ratio limit RLMT.

The map of FIG. 5 is a table representing relationship among the variable nozzle opening degree AVG, the exhaust flow rate, and the expansion ratio. In FIG. 5, as the variable nozzle opening degree AVG, five predetermined values AVG1 to AVG5 from AVG1 (opening degree=100%) to AVG5 (opening degree=0%) are exemplified. In addition, the relationship among the variable nozzle opening degree AVG, the exhaust flow rate, and the expansion ratio when a required turbine work load WCMD1 is obtained is represented in the map. Further, ROVER and RLMT in FIG. 5 are the extreme expansion ratio and the expansion ratio limit, respectively.

By using the map, the variable nozzle opening degree AVG and the exhaust flow rate are obtained in accordance with the calculated required work load WCMD and the required expansion ratio limit RLMT. In the case where the variable nozzle opening degree AVG determined by the required work load WCMD and the expansion ratio limit RLMT is not on the lines of AVG1 to AVG5, the variable nozzle opening degree AVG is calculated by interpolation calculation.

After the limit value ALMT is calculated at Step 406, in Step 407, whether an acceleration request (e.g., increasing the accelerator opening degree AP) from the vehicle is received is determined. In the case where the answer of Step 407 is “YES”, i.e., the acceleration request is received from the vehicle, Step 410 is performed to set the variable nozzle opening degree AVG to the limit value ALMT calculated in Step 406, and the process ends.

While not shown in FIG. 4, it may also be configured that, in the case where the flow proceeds from Step 407 to Step 410, that is, in the case where the acceleration request is received from the vehicle and the variable nozzle opening degree AVG is set to the limit value ALMT, as a subsequent process, a process of setting a value calculated by adding a predetermined increase amount AA to the current variable nozzle opening degree AVG as a new variable nozzle opening degree AVG during a period until a predetermined time elapses is performed.

Referring to FIG. 4 again, in the case where the answer of Step 407 is “NO”, that is, in the case where the acceleration request from the vehicle is not received, Step 408 is performed. In Step 408, the variable nozzle opening degree AVG is changed through feedback control, so that the supercharging pressure PB becomes the target supercharging pressure PBCMD, and Step 409 is performed.

In Step 409, whether the variable nozzle opening degree AVG is less than the limit value ALMT is determined. When the answer of Step 409 is “YES”, i.e., when the variable nozzle opening degree AVG is set to an opening degree closer to the closed side than the limit value ALMT, Step 410 is performed, the variable nozzle opening degree AVG is set to the limit value ALMT, and the process ends. Alternatively, when the answer of Step 409 is “NO”, i.e., when the variable nozzle opening degree AVG is set to be the same as the limit value ALMT or to an opening degree closer to the open side than the limit value ALMT, Step 411 is performed, the current variable nozzle opening degree AVG is maintained, and the process ends.

With the setting of the variable nozzle opening degree, in the embodiment, the variable nozzle opening degree AVG is set to the limit value ALMT when the acceleration request is received from the vehicle, and when the acceleration request is not received from the vehicle, the variable nozzle opening degree AVG is subjected to feedback control, so that the supercharging pressure PB becomes the target supercharging pressure PBCMD, and in the case where the variable nozzle opening degree AVG falls below the limit value ALMT, the variable nozzle opening degree AVG is set to the limit value ALMT.

According to the embodiment, the limit value ALMT which limits the opening degree AVG on the closed side of the variable nozzle 124 is set based on the expansion ratio limit RLMT, and when the supercharging pressure PB increases toward the target supercharging pressure PBCMD, the variable nozzle opening degree AVG is set to the limit value ALMT. Then, control is exerted to gradually increase the variable nozzle opening degree AVG Accordingly, by limiting the opening degree of the closed side of the variable nozzle 124 based on the expansion ratio limit RLMT of the turbine 121, the failure of the turbo charger 12 is effectively avoided. In addition, by setting the variable nozzle opening degree AVG to the limit value ALMT when the supercharging pressure PB increases toward the target supercharging pressure PBCMD, the overshoot of the supercharging pressure can be prevented from occurring.

Moreover, when the acceleration request from the vehicle is received, by setting the variable nozzle opening degree AVG to the limit value ALMT close to an opening degree of full closure, the supercharging responsiveness can be facilitated.

In addition, since the limit value ALMT of the variable nozzle opening degree AVG is set based on the expansion ratio, which is a ratio between the pressure of the upstream side of the turbine 121 of the turbo charger 12 and the pressure of the downstream side thereof, by reflecting the exhaust temperature, the atmospheric pressure, etc., with respect to the increase of the pressure (exhaust pressure) of the upstream side of the turbine 121, when the exhaust temperature or the atmospheric pressure changes, the failure of the turbo charger 12 can be effectively avoided.

Further, the disclosure is not limited to the above-described embodiment, and may be implemented in various embodiments. For example, in the embodiment, the map of FIG. 5 is used in setting the limit value ALMT of the nozzle opening degree AVG based on the required turbine workload WCMD and the expansion ratio limit RLMT, but the map is merely an example and may be changed as appropriate. In addition, in place of a map, a calculation formula may also be used. In addition, it is possible to appropriately change the detailed configuration within the scope of the spirit of the disclosure.

What is claimed is:

1. A supercharging pressure control device of an internal combustion engine, comprising:
a supercharger, disposed in the internal combustion engine, and configured to increase a supercharging pressure by changing an opening degree of a variable nozzle to a closed side, wherein the supercharger comprises a turbine rotationally driven by kinetic energy of exhaust gas and comprises a compressor provided in an intake path and connected to the turbine via a shaft;
a supercharging pressure obtaining part, obtaining the supercharging pressure;
a limit value setting part, setting a limit value which limits the opening degree of the closed side of the variable nozzle based on a pressure of a turbine side of the supercharger; and
an opening degree setting part, setting the opening degree of the variable nozzle to the limit value when the supercharging pressure is increased toward a target supercharging pressure, and then gradually setting the opening degree of the variable nozzle to an open side.

2. The supercharging pressure control device as claimed in claim 1, wherein the limit value of the opening degree of the variable nozzle is a value smaller than an opening degree corresponding to the target supercharging pressure and greater than an opening degree of full closure.

3. The supercharging pressure control device as claimed in claim 1, wherein the pressure of the turbine side is an expansion ratio which is a ratio between a pressure of an upstream side of a turbine and a pressure of a downstream side of the turbine.

4. The supercharging pressure control device as claimed in claim 2, wherein the pressure of the turbine side is an expansion ratio which is a ratio between a pressure of an upstream side of a turbine and a pressure of a downstream side of the turbine.
